(19) United States
(12) Patent Application Publication
(10) Pub. No.: US 2026/0252314 A1
(43) Pub. Date: Aug. 27, 2026

(54) CONTEXT-AWARE RENAMING OF OBJECTS IN APPLICATIONS

(71) Applicant: Microsoft Technology Licensing, LLC, Redmond, WA (US)

(72) Inventors: Emma Margaret Belle COOPER, Kenmore, WA (US); Mansi MALIK, Lynnwood, WA (US); Chen-mi LIN, Snoqualmie, WA (US); Akshar Virendrabhai PATEL, Alpharetta, GA (US); Zhiqi FU, Redmond, WA (US); Anh Ngoc Tuan TRUONG, La Puente, CA (US); Shantanu Kiran PAKHARE, Redmond, WA (US); Jayant DHAWAN, Bothell, WA (US); Anshuman ANSU, Issaquah, WA (US)

(21) Appl. No.: 19/061,511

(22) Filed: Feb. 24, 2025

(51) Int. Cl. G06F 8/20; G06F 8/34

(52) U.S. Cl. CPC G06F 8/24; G06F 8/34

(57) ABSTRACT

A system may access names of the named objects stored in memory and context information within the application including object attributes of the named objects and an object hierarchy specifying hierarchical relationships among the named objects. The system may generate a generative artificial intelligence model input including at least a portion of the context information and request generation of one or more suggested names based on the at least the portion of the context information included in the generative artificial intelligence model input. The system may present the one or more suggested names for the named object. The system may receive a selection of a suggested name to yield a selected suggested name corresponding to the named object. The system may rename the named object in the memory with the selected suggested name.

### BACKGROUND

In the low code/no-code applications market, where objects (e.g., buttons, labels, folders, forms, etc.) can be added with a single click, an application can include hundreds of these elements, which are generally default names, such as “Button1” or “File2.” Renaming each object to a meaningful name is a tedious but essential task for the maintainability of the application, particularly when multiple developers are involved.

### SUMMARY

In some aspects, the techniques described herein relate to a method of renaming named objects within an application, the method including: accessing names of the named objects stored in memory and context information corresponding to the named objects within the application, each named object corresponding to an object name, the context information including an object hierarchy specifying hierarchical relationships among the named objects within the application; constructing one or more suggested names for a named object of the named objects by generating a generative artificial intelligence model input including at least a portion of the context information and requesting generation of the one or more suggested names based on the at least the portion of the context information included in the generative artificial intelligence model input; receiving the one or more suggested names from execution of a generative artificial intelligence model on the generative artificial intelligence model input; presenting the one or more suggested names for the named object; receiving a selection of a suggested name to yield a selected suggested name corresponding to the named object; and renaming the named object in the memory by replacing the object name corresponding to the named object stored in the memory with the selected suggested name.

In some aspects, the techniques described herein relate to a system for renaming named objects of an application, including: one or more hardware processors; an object names identifier stored in memory and executable by the one or more hardware processors and configured to perform operations including accessing names of the named objects stored in memory, each named object corresponding to an object name; a context information selector stored in the memory and executable by the one or more hardware processors and configured to perform operations including selecting context information corresponding to the named objects within the application, the context information including an object hierarchy specifying hierarchical relationships among the named objects within the application; an object names generator stored in the memory executable by the one or more hardware processors and configured to perform operations including one or more suggested names for a named object of the named objects by generating a generative artificial intelligence model input including at least a portion of the context information and requesting generation of the one or more suggested names based on the at least the portion of the context information included in the generative artificial intelligence model input; and an object renamer stored in the memory and executable by the one or more hardware processors and configured to perform operations including: receiving the one or more suggested names from execution of a generative artificial intelligence model on the generative artificial intelligence model input; presenting the one or more suggested names for the named object; receiving a selection of a suggested name to yield a selected suggested name corresponding to the named object; and renaming the named object in the memory by replacing the object name corresponding to the named object stored in the memory with the selected suggested name.

In some aspects, the techniques described herein relate to one or more tangible processor-readable storage media embodied with instructions for executing on one or more processors and circuits of a computing device a process for renaming named objects of an application, the process including: accessing names of the named objects stored in memory and context information corresponding to the named objects within the application, each named object corresponding to an object name, the context information including an object hierarchy specifying hierarchical relationships among the named objects within the application; constructing one or more suggested names for a named object of the named objects by generating a generative artificial intelligence model input including at least a portion of the context information and requesting generation of the one or more suggested names based on the at least the portion of the context information included in the generative artificial intelligence model input; receiving the one or more suggested names from execution of a generative artificial intelligence model on the generative artificial intelligence model input; presenting the one or more suggested names for the named object via a user interface of a computing device for selection; receiving a selection of a suggested name via the user interface to yield a selected suggested name corresponding to the named object; and responsive to receiving an input at the user interface, renaming the named object in the memory by replacing the object name corresponding to the named object stored in the memory with the selected suggested name.

This summary is provided to introduce a selection of concepts in a simplified form that are further described below in the Detailed Description. This summary is not intended to identify key features or essential features of the claimed subject matter, nor is it intended to be used to limit the scope of the claimed subject matter.

Other implementations are also described and recited herein.

### BRIEF DESCRIPTIONS OF THE DRAWINGS

FIG. 1 illustrates an example computing environment for generating object renaming suggestions for a set of objects of an application and renaming the set of objects in accordance with the object renaming suggestions.

FIG. 2 illustrates an example user interface providing a tree view of named objects of a portion of an application and an option to view renaming suggestions for the named objects.

FIG. 3 illustrates an example user interface for the selection of object renaming suggestions for a set of named objects of an application and for initiating a renaming operation for one or more of the set named objects corresponding to the selected object renaming suggestions.

FIG. 4 illustrates an example user interface displaying renamed objects in a tree view of an application corresponding to renaming operations performed on named objects corresponding to selected object renaming suggestions.

FIG. 5 illustrates an example user interface displaying renamed objects in a user interface of an application corresponding to renaming operations performed on named objects corresponding to selected object renaming suggestions.

FIG. 6 illustrates an example user interface for the selection of object renaming suggestions for a set of named objects of an application and, for initiating a renaming operation for one or more of the set named objects corresponding to the selected object renaming suggestions, and for renaming all objects of the application.

FIG. 7 illustrates an example user interface for providing, within a tree view 730 of an application, a set of suggested object names for renaming a selected named object.

FIG. 8 illustrates an example computing environment for generating, with the assistance of a language model, object renaming suggestions for a set of objects of an application and renaming the set of objects in accordance with the object renaming suggestions.

FIG. 9 depicts an example of operations for renaming named objects of an application.

FIG. 10 illustrates an example computing device for use in implementing the described technology.

### DETAILED DESCRIPTIONS

Some methodologies for renaming an object involve selecting the object via the user interface and then entering a new name for the selected object that is meaningful for the application or using a find-and-replace feature. For example, a meaningful object renaming scheme may involve a naming convention that is specific to the application or to the user. However, repeating the renaming process for multiple objects of the application is a tedious process and can yield inconsistently renamed objects when the developer makes errors when entering names or in scenarios in which multiple developers are involved in the renaming.

The disclosed technology addresses these inadequacies of renaming objects by providing an object name generator that provides object renaming suggestions for a set of objects of an application based on context information. The application may be a mobile application, a website, a file directory, or other application that includes objects. Objects may be one or more interactive user interface objects (e.g., buttons, links, dropdown menus, text fields, sliders, icons, checkboxes, etc.), folders or files in a directory of a storage system, page names in a hierarchical website layout, slides of a presentation, or other set of objects that can be renamed. The set of objects may have default names (e.g., object1, object1-1, object1-2, menu1, menu2, etc.) assigned to the object at the time of generation of the objects and/or names previously given to the objects by the user (e.g., previous renames). The set of objects may be all objects of the application or a subset of the objects of the application. For example, the subset of the objects may be objects on a page of a website, objects of a user interface screen of an application, or objects of a subfolder (e.g., further subfolders and/or files) of a directory.

Context information may include external context information and/or internal context information. External context information may include a renaming scheme for renaming objects of the application. Internal context information may include a spatial layout of objects of the application, including the set of objects, an object hierarchy defining hierarchical relationships (e.g., subfolders within folders, fields/checkboxes/menus that are within a form, etc.) among objects of the application including the set of objects, and/or any previous renaming of the objects of the application including the set of objects. Internal context information may include attributes of the objects, for example, text corresponding to the objects (e.g., text on a button object, a title of a file object). The context information may be important for informing renaming suggestions provided by the object name generator. For example, some object renaming schemes may incorporate positional/layout information and hierarchical relationships among objects into the names of objects. For example, a renaming scheme may specify that a first button that is spatially to the left of a second button includes the suffix “left” in its name, and the second button includes the suffix “right” in its name. In another example, the renaming scheme may specify that a first button that is hierarchically a first child of another button includes a suffix “−1” in its name.

In some implementations, the object name generator generates the renaming suggestions for the set of objects for the set of objects by applying one or more rules of a naming scheme. In some implementations, the object name generator generates inputs (e.g., a query, a prompt, etc.) for a language model (e.g., a large language model) from the names of the set of objects and from the context information and generates the renaming suggestions based on outputs of the language model. In some implementations, the object name generator includes a language model that generates the renaming suggestions based on the names of the set of objects and the context information. The renaming suggestions may include one or more new names for each object of the set of objects.

Certain implementations of the disclosed technology provide an object renamer that presents the renaming suggestions for the set of objects generated by the object name generator based on the context information (e.g., internal context information and/or external context information) for the suggestion to the developer of the application via a user interface. In some implementations, the object renamer renames the set of objects responsive to confirmation of the renaming suggestions by the developer via the user interface. In some implementations, suggesting the renaming suggestions may include presenting the renaming suggestions via the user interface and providing options (e.g., via buttons or other user interface objects) that enable the developer to confirm the renaming of the set of objects in accordance with the renaming suggestions responsive to the developer confirming (e.g., by clicking a button) the suggested renaming of the set of objects. In some implementations, the object renamer presents the renaming suggestions for the set of objects for individual selection/confirmation (e.g., via selection and/or deselection of checkboxes) by the developer, and the developer may select one or more of the set of renaming suggestions.

The disclosed technology ensures that objects of an application are renamed with consistent, nonconflicting, and context-informed renaming suggestions. Consequently, applications having objects renamed using the object name generator and object renamer of the disclosed technology have significantly improved object names over objects renamed using manual renaming schemes and find-and-replace renaming schemes, which are prone to error. The disclosed technology also improves navigation of conventional user interfaces for renaming objects by providing renaming suggestions for a set of objects via a user interface object and performing renaming operations for the set of objects responsive to receiving a confirmation of the renaming suggestions via the user interface. Accordingly, the disclosed technology reduces the number of user interface inputs (e.g., clicks) required in renaming approaches that require sequential selection of objects for renaming followed by input of names or require a series of find-and-replace operations.

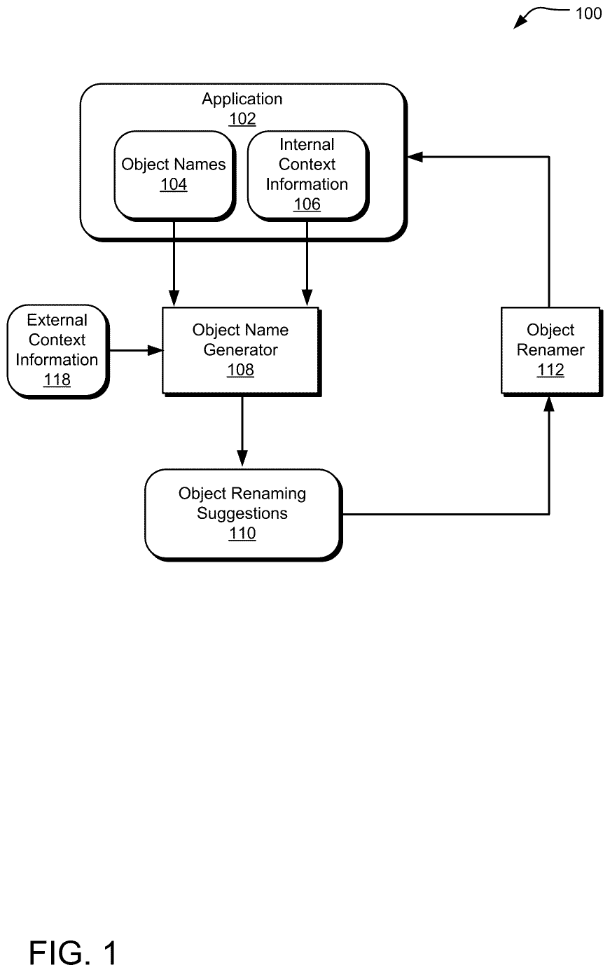

FIG. 1 illustrates an example computing environment 100 for generating object renaming suggestions 110 for a set of objects of an application 102 and renaming the set of objects in accordance with the object renaming suggestions 110. The example computing environment 100 includes an object name generator 108 and an object renamer 112.

The application 102 may be a mobile application, a website, a file directory, or another application that includes objects. Objects may be one or more interactive user interface objects (e.g., buttons, links, dropdown menus, text fields, sliders, icons, checkboxes, etc.), folders or files in a directory of a storage system, page names in a hierarchical website layout, slides of a presentation, or other set of objects that can be renamed.

The object name generator 108 generates object renaming suggestions 110 for a set of objects of an application 102. In some implementations, the object name generator 108 is provided by a development application that is executed on a computing device of a developer (e.g., a standalone application) or otherwise accessed by the developer using the computing device (e.g., via a web-based application). The development application may be used to edit the content (e.g., including objects, text, images, and other content) of the application 102. The development application may further include the object renamer 112, which can rename one or more of the set of objects with names in the corresponding object renaming suggestions 110. The development application may have access to programming code of the application 102 and is able to edit the content of the application 102 by editing the programming code. In some implementations, the application 102 may include one or more of the object name generator 108 or the object renamer 112.

The object name generator 108 generates the object renaming suggestions 110 based on object names 104 for the set of objects and based on context information (e.g., internal context information 106 and/or external context information 118). For example, the object name generator 108 receives or otherwise accesses object names 104 of a set of objects of an application 102 and internal context information 106 for the set of objects of the application 102. For example, the object names 104 may be stored in one or more of the program code or the program data of the application 102 accessible to the object name generator 108. The set of objects may include all objects of the application 102. The set of objects may include a subset of the objects of the application 102, for example, a set of objects appearing in one section (e.g., in a page, in a screen, in a tab, in a subfolder, etc.) of the application 102. The set of objects may include a subset of the objects of the application 102 currently being displayed in a user interface (e.g., displayed to a developer).

The set of objects may have default object names 104 (e.g., object1, object1-1, object1-2, menu1, menu2, etc.) assigned to the set of objects at the time of generation of the objects and/or names previously given to the objects by the user (e.g., previous renames). For example, each of the set of objects has a corresponding object name. The set of objects may be all objects of the application or a subset of the objects of the application. For example, the subset of the objects may be objects on a page of a website, objects of a user interface screen of an application, or objects of a subfolder (e.g., further subfolders and/or files) of a directory. The set of objects may be located in one or more sections (e.g., pages, tabs, etc.) of the application 102. The application 102 may be an application under development (e.g., not yet available for download/access) and may include a set of named objects having the object names 104.

The object name generator 108 receives or otherwise accesses context information to inform its generation of object renaming suggestions 110. Context information may include external context information 118 and internal context information 106. External context information 118 may include a renaming scheme for renaming objects of the application. The renaming scheme may be defined by the developer, defined by a convention (e.g., for applications of the same type as the application 102), or may be a default renaming scheme. The renaming scheme may define a format for object names, for example, the renaming scheme may specify that menus be named in the format “menu-name-X-N,” where X denotes a section (e.g., page, tab, subfolder) identifier and N denotes that the menu is the nth menu located in the section identified by the section identifier, and “name” denotes a name to be given to the menu based on the content of the menu.

Internal context information 106 may include a spatial layout of objects of the application, including the set of objects, an object hierarchy defining hierarchical relationships (e.g., subfolders within folders, fields/checkboxes/menus that are within a form, etc.) among objects of the application including the set of objects, and/or any previous renaming of the objects of the application including the set of objects. For example, the context information may be important for informing renaming suggestions provided by the object name generator. For example, some object renaming schemes may incorporate positional/layout information and hierarchical relationships among objects into the names of objects. For example, a renaming scheme may specify that a first button that is spatially to the left of a second button includes the suffix “left” in its name, and the second button includes the suffix “right” in its name. In another example, the renaming scheme may specify that a first button that is hierarchically a first child of another button includes a suffix “−1” in its name.

In some implementations, the object name generator 108 generates inputs for a machine learning model (e.g., a language model) based on the context information (e.g., internal context information 106 and/or external context information 118) and the object names 104 and then determines the object renaming suggestions 110 based on outputs of the machine learning model. For example, the inputs may include a prompt that states, “generate object names to replace object name A, object name B, and object name C,” and further includes the context information. In some implementations, the object name generator 108 includes the machine learning model and generates the object renaming suggestions 110 by inputting the context information and object names 104 into the machine learning model.

The object renamer 112 presents the object renaming suggestions 110 for the set of objects generated by the object name generator based on the context information (e.g., internal context information and/or external context information) for suggestion to the developer of the application via a user interface. In some implementations, the object renamer renames the set of objects responsive to confirmation of the renaming suggestions by the developer via the user interface. Renaming the set of objects includes changing the names of the objects in the programming code of the application 102 in accordance with the object renaming suggestions 110. For example, the object renamer 112 changes the object names 104 to the corresponding names of the object renaming suggestions 110.

In some implementations, the object renamer 112 presents the object renaming suggestions via a user interface (e.g., a user interface of the developer application) and provides options (e.g., via buttons or other user interface objects) that enable the developer to confirm renaming of the set of objects in accordance with the object renaming suggestions 110 responsive to the developer confirming (e.g., by clicking a button) the object renaming suggestions 110 via the user interface. In some implementations, the object renamer 112 presents the object renaming suggestions 110 for the set of objects for individual selection/confirmation (e.g., via selection and/or deselection of checkboxes) by the developer, and the developer may select one or more of the object renaming suggestions 110.

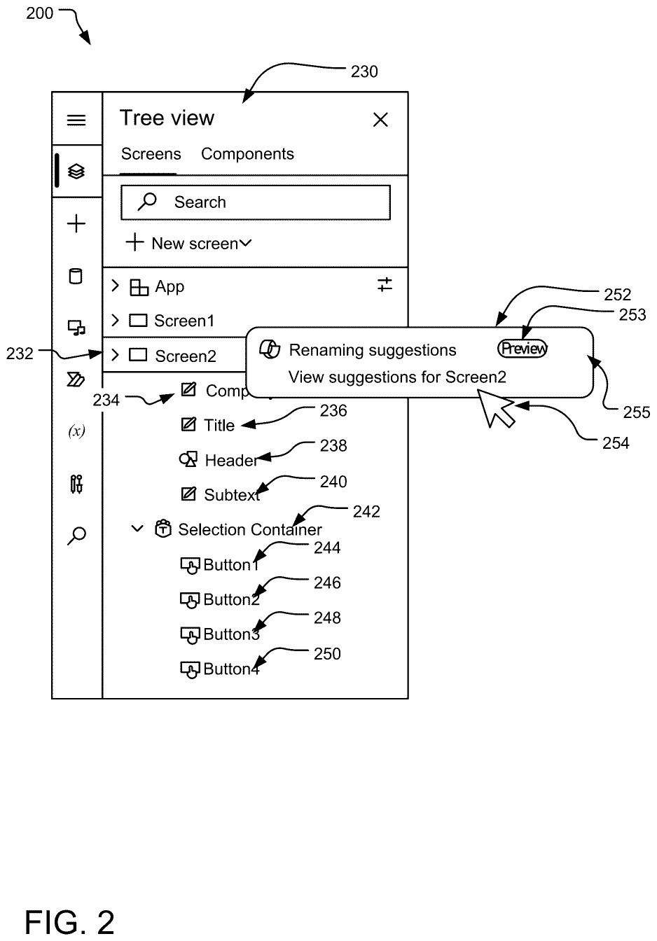

FIG. 2 illustrates an example user interface 200 providing a tree view 230 of named objects of a portion of an application and an option to view renaming suggestions for the named objects. For example, element 232 identifies “Screen2” as a selected portion of the application that includes “Screen1” and “Screen2,” as indicated in the tree view 230. Responsive to a user's (e.g., a developer's) selection of element 232 on the user interface 200, the object names of named objects located within the Screen2 portion are displayed. For example, element 234 indicates a named object having the name “Compare,” element 236 indicates a named object having the name “Title,” element 238 indicates a named object having the name “Header,” element 240 indicates a named object having the name “Subtext,” element 242 indicates a named object having the name “Selection Container,” element 244 indicates a named object having the name “Button1,” element 246 indicates a named object having the name “Button2,” element 248 indicates a named object having the name “Button3,” and element 250 indicates a named object having the name “Button4.” As indicated via the tree view 230 using indentation of elements, the Button1, Button2, Button3, and Button4 named objects are hierarchically related to (e.g., they are within) the Selection Container named object.

The example user interface 200 also displays a renaming suggestions request user interface object 252. For example, an object name generator generates, responsive to a selection of element 232 that corresponds with the Screen2 portion of the application, a set of object name suggestions for the named objects (e.g., one or more name suggestions for named objects corresponding to each of element 236, element 238, element 240, element 242, element 244, element 246, element 248, and element 250) and an object renamer causes the display of the renaming suggestions request user interface object 252. For example, the renaming suggestions request user interface object 252 reads “Renaming Suggestions” to describe the content (e.g., the renaming suggestions) that may be presented to the developer responsive to clicking a preview object 253. The object renamer is configured to display, responsive to the selection of preview object 253 within the renaming suggestions request user interface object 252 (e.g., using the cursor 254), the renaming suggestions. The object renamer, responsive to the selection of cancel object 255 (e.g., indicated as an “X”) within the renaming suggestions request user interface object 252 (e.g., using the cursor 254), ceases to display the renaming suggestions request user interface object 252.

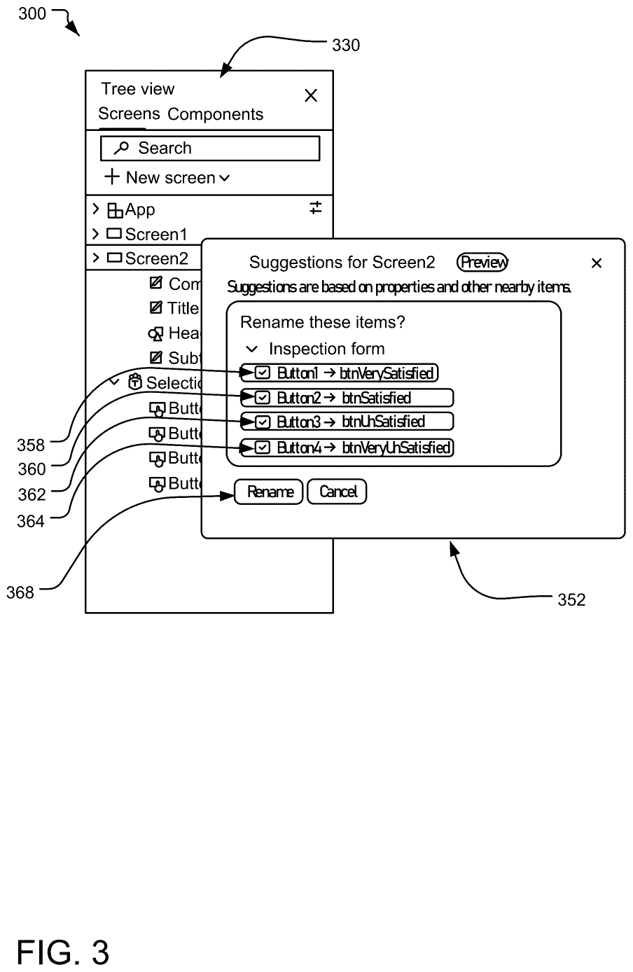

FIG. 3 illustrates an example user interface 300 for the selection of object renaming suggestions for a set of named objects of an application and for initiating a renaming operation for one or more of the set named objects corresponding to the selected object renaming suggestions. The example user interface 300 displays a tree view 330 of named objects of an application. The example user interface 300 also displays a renaming suggestions request user interface object 352. For example, an object renamer is configured to display, responsive to the selection of a preview object within the renaming suggestions request user interface object 352 (e.g., as depicted in FIG. 2), the renaming suggestions. For example, the renaming suggestions request user interface object 352 displays suggested renaming operations for named objects including “Button1,” Button2,” “Button3,” and “Button4.” For example, the suggested renaming operations, as depicted in FIG. 3 using arrows, suggest renaming Button1 as “btnVerySatisfied,” renaming Button2 as “btnSatisfied,” renaming Button3 as “btnUnsatisfied,” and renaming Button4 as “btnVeryUnsatisfied.” Further, the renaming suggestions request user interface object 352 displays, for each of the four examples suggested renaming operations, a corresponding selection box (e.g., selection box 358, selection box 360, selection box 362, and selection box 364) enabling selection or non-selection of the renaming suggestion. In the example depicted in FIG. 3, each of the four selection boxes is depicted as selected. However, the user (e.g., the developer) may choose to unselect one or more of the selection boxes to indicate which renaming operations are desired. Responsive to receiving a selection of the rename interface object 368, the object renamer performs the suggested renaming operations corresponding to selected selection boxes. For example, responsive to the selection of the rename interface object 368 and to determining that each of selection box 358, selection box 360, selection box 362, and selection box 364 is selected, the object renamer renames Button1 as “btnVerySatisfied,” renames Button2 as “btnSatisfied,” renames Button3 as “btnUnsatisfied,” and renames Button4 as “btnVeryUnsatisfied.” The object renamer, responsive to the selection of cancel object 370 within the renaming suggestions request user interface object 352, ceases to display the renaming suggestions request user interface object 352.

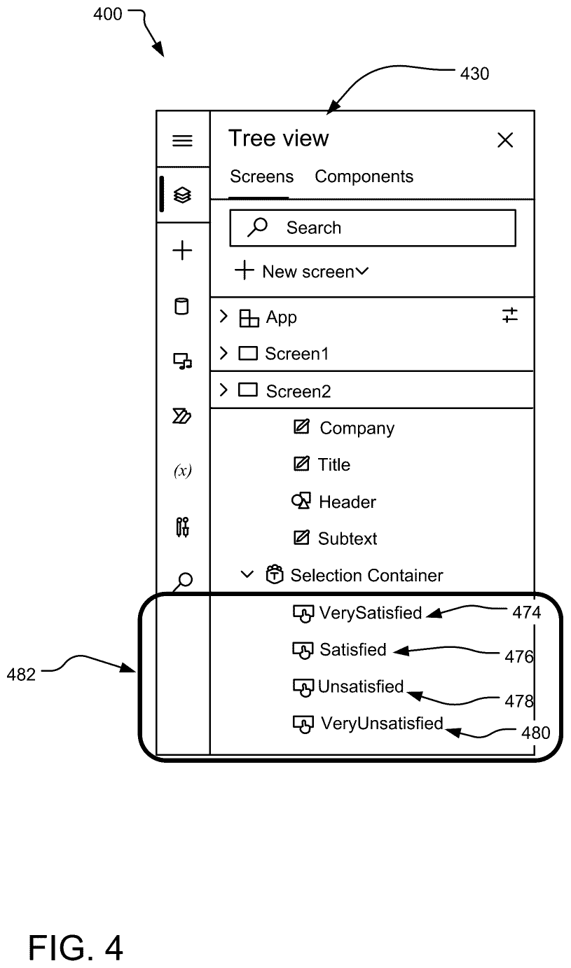

FIG. 4 illustrates an example user interface 400 displaying renamed objects in a tree view 430 of an application corresponding to renaming operations performed on named objects corresponding to selected object renaming suggestions. For example, the renaming operations may be requested using the user interface depicted in FIG. 3. For example, responsive to one or more selections of interface objects via a user interface, the object renamer renames a first named object from “Button1” to “btnVerySatisfied,” renames a second named object from Button2 to “btnSatisfied,” renames a third named object from “Button3” to “btnUnsatisfied,” and renames a fourth named object from “Button4” to “btnVeryUnsatisfied. A set of renamed named objects 482 is depicted in the tree view 430, including the renamed first named object depicted in element 474, the renamed second object depicted in element 476, the renamed third object depicted in element 478, and the renamed fourth object depicted in element 480.

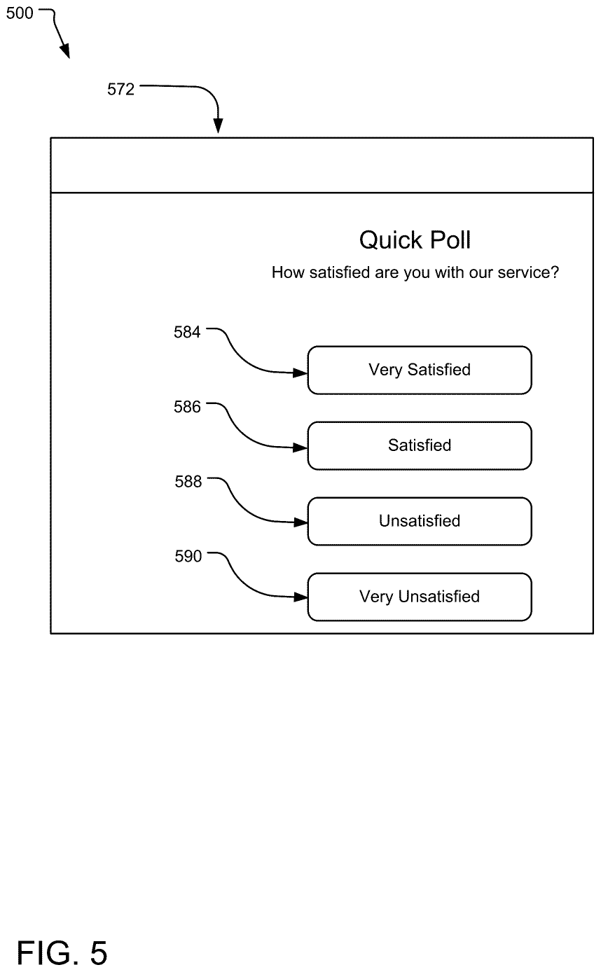

FIG. 5 illustrates an example user interface 500 displaying renamed objects in a user interface of an application corresponding to renaming operations performed on named objects corresponding to selected object renaming suggestions. For example, the renaming operations may be requested using the user interface depicted in FIG. 3. For example, responsive to one or more selections of interface objects via a user interface, the object renamer renames a first named object from “Button1” to “btnVerySatisfied,” renames a second named object from Button2 to “btnSatisfied,” renames a third named object from “Button3” to “btnUnsatisfied,” and renames a fourth named object from “Button4” to “btnVeryUnsatisfied. A set of renamed named objects is depicted in the interface 572 (e.g., titled “Vertex Dynamics”), including the renamed first named object depicted in element 584, the renamed second object depicted in element 586, the renamed third object depicted in element 588, and the renamed fourth object depicted in element 590.

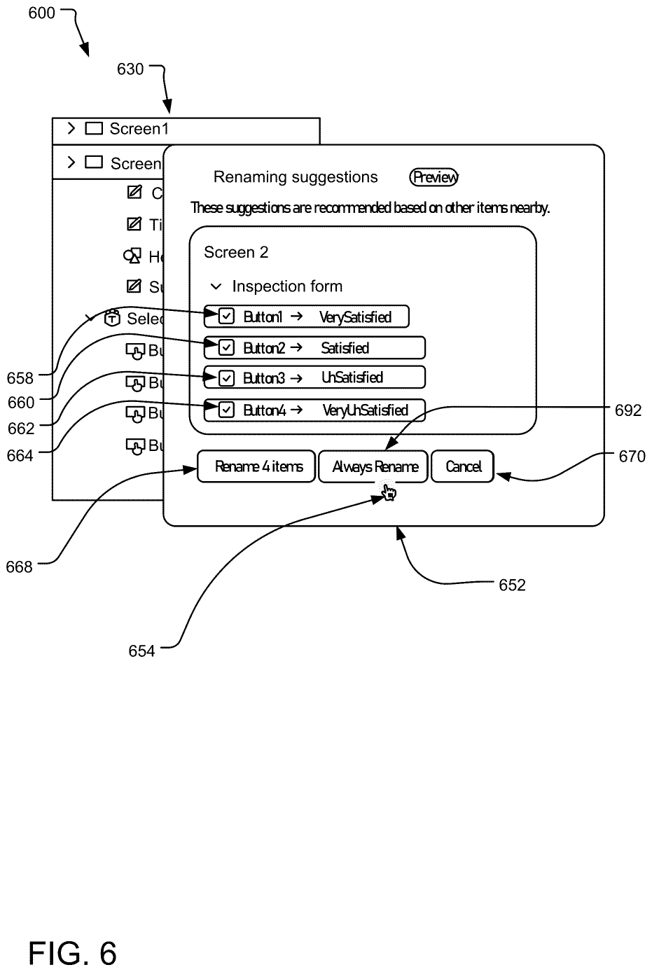

FIG. 6 illustrates an example user interface 600 for selection of object renaming suggestions for a set of named objects of an application and for initiating a renaming operation for one or more of the set named objects corresponding to the selected object renaming suggestions, and for renaming all objects of the application. The example user interface 600 displays a tree view 630 of named objects of an application. The example user interface 600 also displays a renaming suggestions request user interface object 652. For example, an object renamer is configured to display, responsive to selection of a preview object within the renaming suggestions request user interface object 652 (e.g., as depicted in FIG. 2), the renaming suggestions. For example, the renaming suggestions request user interface object 652 displays suggested renaming operations for named objects including “Button1,” Button2,” “Button3,” and “Button4.” For example, the suggested renaming operations, as depicted in FIG. 6 using arrows, suggest renaming Button1 as “btnVerySatisfied,” renaming Button2 as “btnSatisfied,” renaming Button3 as “btnUnsatisfied,” and renaming Button4 as “btnVeryUnsatisfied.” Further, the renaming suggestions request user interface object 652 displays, for each of the four examples suggested renaming operations, a corresponding selection box (e.g., selection box 658, selection box 660, selection box 662, and selection box 664) enabling selection or non-selection of the renaming suggestion. In the example depicted in FIG. 6, each of the four selection boxes is depicted as selected. However, the user (e.g., the developer) may choose to unselect one or more of the selection boxes to indicate which renaming operations are desired. Responsive to receiving a selection of the rename interface object 668 (which reads “Rename 4 items”), the object renamer performs the suggested renaming operations corresponding to selected selection boxes. For example, responsive to selection of the rename interface object 668 and to determining that each of selection box 658, selection box 660, selection box 662, and selection box 664 is selected, the object renamer renames Button1 as “btnVerySatisfied,” renames Button2 as “btnSatisfied,” renames Button3 as “btnUnsatisfied,” and renames Button4 as “btnVeryUnsatisfied.” The object renamer, responsive to selection of cancel object 670 within the renaming suggestions request user interface object 652, cease to display the renaming suggestions request user interface object 652. The object renamer, responsive to selection of interface object 692 (e.g., via cursor 654 as indicated), which reads “Always rename,” renames all named objects in the application, in addition to the renaming operations to the named objects displayed in the renaming suggestions request user interface object 652, in accordance with object renaming suggestions generated by the object names generator for the named objects. For example, responsive to the selection of the “Always rename” interface object, the object renamer will not show the user interface requesting approval for future renaming suggestions going forward and object renaming suggestions are automatically applied.

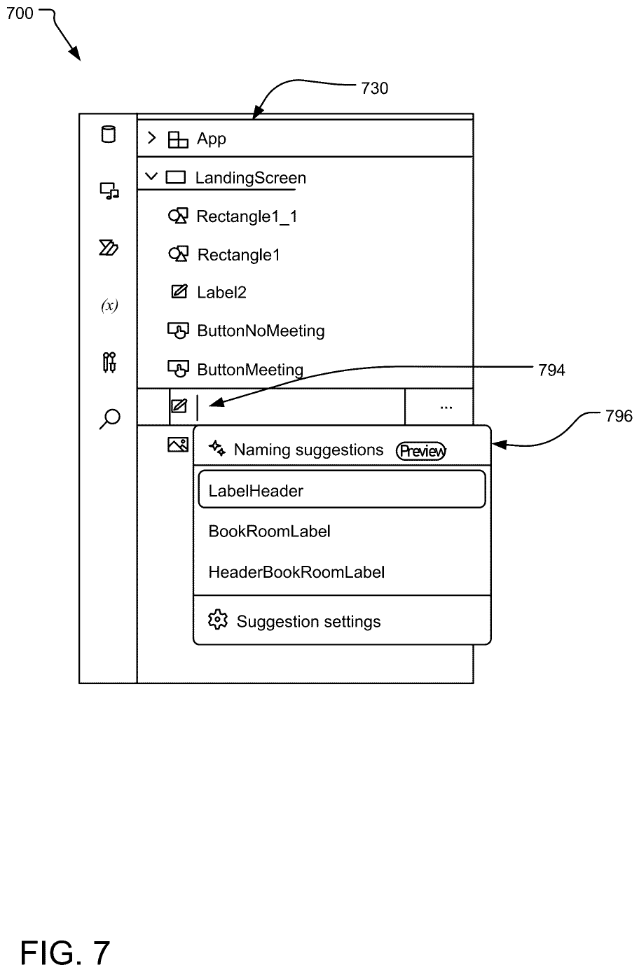

FIG. 7 illustrates an example user interface 700 for providing, within a tree view 730 of an application, a set of suggested object names for renaming a selected named object. For example, the tree view 730 depicts named objects including “LandingScreen,” “Rectangle1_1,” “Rectangle1,” “Label2,” “ButtonNoMeeting,” and selected named object 794 (original name not depicted). For example, the original name of the selected named object 794 may be “Header1.” Responsive to receiving the selection of selected named object 794, the objects name generator generates renaming suggestions (e.g., suggested names “LabelHeader,” BookRoomLabel,” and “HeaderBookRoomLabel”) for the selected named object 794 and presents the renaming suggestions via the naming suggestions selection interface object 796. The user (e.g., the developer) may select the “LabelHeader” renaming suggestion, as indicated in FIG. 7. Responsive to receiving the selection of the selected renaming suggestion, the object renamer renames the selected named object 794 from its original name (e.g., “Header1”) to the name of the selected naming suggestion (e.g., “LabelHeader.”).

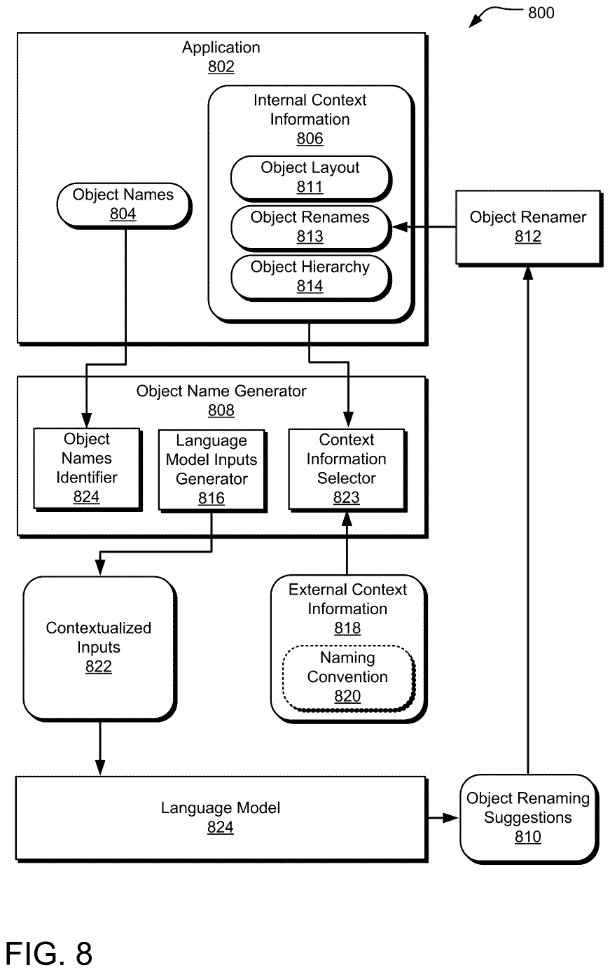

FIG. 8 illustrates an example computing environment 800 for generating, with the assistance of a language model 824, object renaming suggestions 810 for a set of objects of an application 802 and renaming the set of objects in accordance with the object renaming suggestions 810. The example computing environment 800 includes an application 802, an object name generator 808, a language model 824, and an object renamer 812.

The object name generator 808 generates object renaming suggestions 810 for a set of objects of an application 802. In some implementations, the object name generator 808 is provided by a development application that is executed on a computing device of a developer (e.g., a standalone application) or otherwise accessed by the developer using the computing device (e.g., via a web-based application). The development application may be used to edit the content (e.g., including objects, text, images, and other content) of the application 802. The development application may further include the object renamer 112 which can rename one or more of the set of objects with names in the corresponding object renaming suggestions 810. The development application may have access to programming code of the application 802 and enables the developer to edit the content of the application 802 by editing the programming code. For example, a developer duplicates a component containing many controls, which would typically lead to a copy of component and all children component names as well, irrelevant, and confusing names. The implementation depicted in FIG. 8 enables bulk renaming of controls to reduce the usual interface navigation required (e.g., reducing the number of clicks) to individually select and rename all controls after duplicating a screen.

The object names identifier 824 receives or otherwise accesses object names 804 from a memory. The context information selector 823 receives or otherwise accesses internal context information 806 and external context information 818 for a set of objects of the application 802. The language model inputs generator 816 generates contextualized inputs 822 using language model inputs generator 816. The contextualized inputs 822 are generated based on the context information (e.g., internal context information 806 and/or external context information 818) and the object names 804. The language model 824 receives the contextualized inputs 822 and outputs the object renaming suggestions 810. The internal context information may include one or more of an object layout 811, object renames 813, and an object hierarchy 814. The internal context information is stored in a memory accessible to the object name generator 808.

The object layout 811 identifies a position of each of the set of objects in the application 802. The position may be an absolute position (e.g., using coordinates) or a relative position (e.g., object A is above object B, object B is on a left side of a screen, object C is rotated by 45 degrees, etc.). The object hierarchy 814 defines hierarchical relationships (e.g., subfolders within folders, fields/checkboxes/menus that are within a form, etc.) among objects of the application 802, including the set of objects. The object hierarchy 814 may be represented using a graph structure (e.g., nodes denoting objects and links between nodes denoting hierarchical relationships between objects), a tabular structure, or other structure that defines relationships between objects. For example, a relationship may denote a parent-child relationship, a sibling relationship (e.g., two objects are children of a common parent object), or other relationship between specified objects. The object renames 813 specify one or more renaming operations that have been performed on the set of objects. For example, the object renames 813 specify that object A has been renamed from “Button1” to “Form-1-Confirmation-Button-1,” because the developer wanted to specify that object A is a button that lies within a first form of a page of the application 802. By the developer renaming one or more such objects in a consistent manner, the object renames 813 may establish a pattern (e.g., the developer renames objects in a way that incorporates relationships in the object hierarchy 814 and a specific numbering scheme) that can be included in inputs 822 the language model 824 to generate the object renaming suggestions 810.

The language model inputs generator 816 generates the contextualized inputs 822 based on the internal context information 806 (e.g., the object layout 811, the object renames 813, and/or the object hierarchy), the external context information (e.g., a naming convention 820), and the object names 804. The contextualized inputs 822 may include a prompt to be input to the language model 824. For example, the prompt states “generate object names to replace object name A, object name B, and object name C” and further includes the context information, for example, an object renaming scheme, positional information for objects A, B, C, and/or any other objects of the application 802, and/or an object hierarchy that includes relationships of objects A, B, and C to each other and/or to any other objects of the application 802. In some implementations, the language model inputs generator 816 applies one or more rules to select a portion of the internal context information 806 and the external context information (e.g., rules that select the most important portion of the context information and object names 804) and generates the contextualized inputs 822 based on the selected portion of the context information and the object names 804. In some implementations, the language model inputs generator 816 uses a machine learning model to select the most important portion of the context information.

The language model 824, in some implementations, is trained to process and respond to input data and to provide output data responsive to input data. In some implementations, the object name generator 808 inputs the contextualized inputs 822 (for example, a natural language query) to the language model 824 and the language model 824 generates output data including the object renaming suggestions 810 based on the contextualized inputs 822. In some implementations, the language model 824 is a large language model (LLM), for example, transformer-based models (e.g., a generative pre-trained transformer (GPT) model, an Open Pretrained Transformer (OPT) model, a Bioscience Large Open-science Open-access Multilingual (BLOOM) model), a seq2seq model, a long short-term memory networks (LSTM), a recurrent neural network (RNN), or other machine learning model.

In some implementations, the language model 824 selects contextual information (e.g., internal, or external) that was included in the contextualized inputs 822 and generates the object renaming suggestions 810 from the determined selected contextual information. For example, For example, a button on a form with an onclick attribute to submit the form can be renamed btnSubmitOrderForm. In this example, the language model 824 identifies the most fitting attribute for the object, i.e., the onclick property, understands that the property code refers to form submission, and extracts context from the ‘form’ parent control. In another example, all named objects of a same type along with their internal context information 806 are including in the contextualized inputs 822, and the language model 824 analyzes all these objects together in context to generate unique, nonconflicting yet relevant object renaming suggestions 810. Similar types of controls (for example, buttons) may have similar contextualized inputs 822 to be analyzed, making generating renaming suggestions 810 efficient for the language model 824.

The object renamer 812 presents the object renaming suggestions 810 for the set of objects generated by the object name generator based on the context information (e.g., internal context information and/or external context information) for suggestion to the developer of the application 802 via a user interface, for example, a user interface of a computing device of the developer. In some implementations, the object renamer 812 renames the set of objects responsive to confirmation of the renaming suggestions by the developer via the user interface. Renaming the set of objects includes changing the object names 804 in the programming code of the application 802 in accordance with the object renaming suggestions 810. For example, the object renamer 812 changes the object names 804 to the corresponding names of the object renaming suggestions 810.

In some implementations, the object renamer 812 presents the object renaming suggestions via the user interface (e.g., a user interface of the developer application) and provides options (e.g., via buttons or other user interface objects) that enable the developer to confirm renaming of the set of objects in accordance with the object renaming suggestions 810 responsive to the developer confirming (e.g., by clicking a button) the object renaming suggestions 810 via the user interface. In some implementations, the object renamer 812 presents the object renaming suggestions 810 for the set of objects for individual selection/confirmation (e.g., via selection and/or deselection of checkboxes) by the developer and the developer may select one or more of the object renaming suggestions 810.

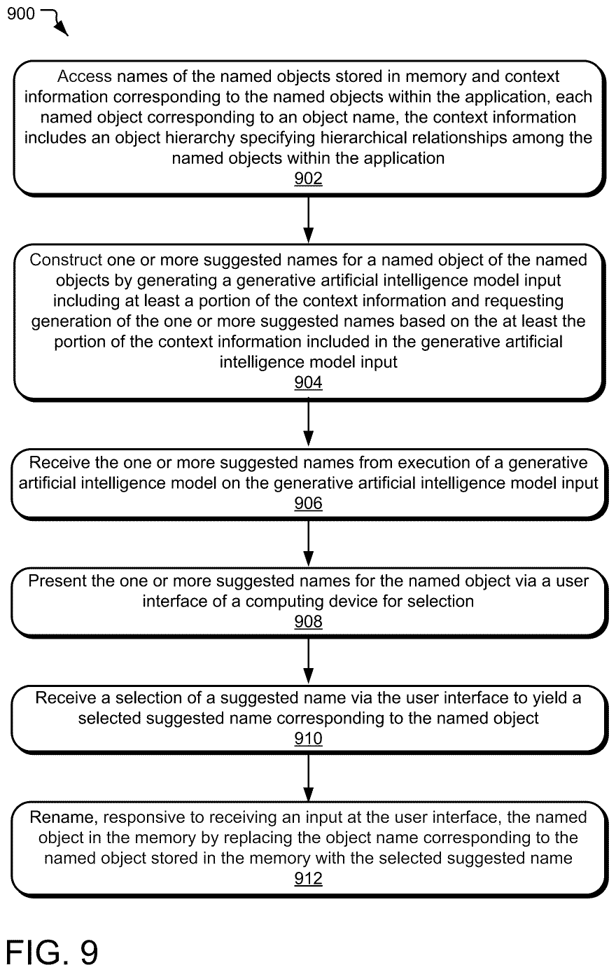

FIG. 9 depicts an example operations 900 for renaming named objects of an application. The example operations 900 are, in some implementations, performed by an object name generator and/or an object renamer.

An example accessing operation 902 accesses names of the named objects stored in memory and context information corresponding to the named objects within the application, each named object corresponding to an object name, the context information includes an object hierarchy specifying hierarchical relationships among the named objects within the application. In some implementations, the context information further includes an indication of a renamed object of the named objects, the renamed object being renamed to the object name from a previous name. In some implementations, the application includes a plurality of portions including a first portion and a second portion, the named object is located in the first portion, and the renamed object is located in the second portion. In some implementations, the application includes a plurality of portions and the named object and the renamed object are located in a same portion of the plurality of portions. In some implementations, the application includes a plurality of portions, the named objects are located in a portion of the plurality of portions, and the object hierarchy specifies hierarchical relationships among the named objects within the portion. In some implementations, the context information includes a renaming scheme specifying a format for renaming suggestions.

An example constructing operation 904 constructs one or more suggested names for a named object of the named objects by generating a generative artificial intelligence model input including at least a portion of the context information and requesting generation of the one or more suggested names based on the at least the portion of the context information included in the generative artificial intelligence model input.

An example receiving operation 906 receives the one or more suggested names from execution of a generative artificial intelligence model on the generative artificial intelligence model input.

An example presenting operation 908 presents the one or more suggested names for the named object.

An example receiving operation 910 receives a selection of a suggested name to yield a selected suggested name corresponding to the named object.

An example renaming operation 912 renames the named object in the memory by replacing the object name corresponding to the named object stored in the memory with the selected suggested name.

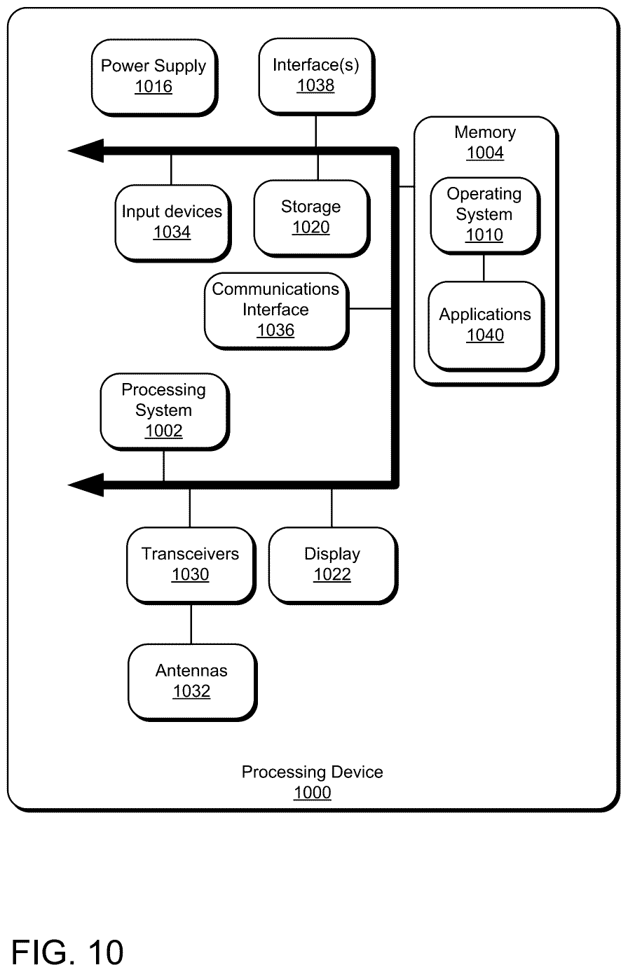

FIG. 10 illustrates an example computing device 1000 for use in implementing the described technology. The computing device 1000 may be a client computing device (such as a laptop computer, a desktop computer, or a tablet computer), a server/cloud computing device, an Internet-of-Things (IoT), any other type of computing device, or a combination of these options. The computing device 1000 includes one or more hardware processor(s) 1002 and a memory 1004. The memory 1004 generally includes both volatile memory (e.g., RAM) and nonvolatile memory (e.g., flash memory), although one or the other type of memory may be omitted. An operating system 1010 resides in the memory 1004 and is executed by the processor(s) 1002. In some implementations, the computing device 1000 includes and/or is communicatively coupled to storage 1020.

In the example computing device 1000, as shown in FIG. 10, one or more software modules, segments, and/or processors, such as applications 1040, an object names generator, an object renamer, a language model, and other program code and modules are loaded into the operating system 1010 on the memory 1004 and/or the storage 1020 and executed by the processor(s) 1002. The storage 1020 may store object names, internal context information, an object layout, object renames, an object hierarchy, language model inputs, language model outputs, object renaming suggestions, renamed objects, embedding spaces, weights, and other data and be local to the computing device 1000 or may be remote and communicatively connected to the computing device 1000. In particular, in one implementation, components of a system for generating object renaming suggestions for a set of objects of an application may be implemented entirely in hardware or in a combination of hardware circuitry and software.

The computing device 1000 includes a power supply 1016, which may include or be connected to one or more batteries or other power sources and which provides power to other components of the computing device 1000. The power supply 1016 may also be connected to an external power source that overrides or recharges the built-in batteries or other power sources.

The computing device 1000 may include one or more communication transceivers 1030, which may be connected to one or more antenna(s) 1032 to provide network connectivity (e.g., mobile phone network, Wi-Fi®, Bluetooth®) to one or more other servers, client devices, IoT devices, and other computing and communications devices. The computing device 1000 may further include a communications interface 1036 (such as a network adapter or an I/O port, which are types of communication devices). The computing device 1000 may use the adapter and any other types of communication devices for establishing connections over a wide-area network (WAN) or local-area network (LAN). It should be appreciated that the network connections shown are exemplary and that other communications devices and means for establishing a communications link between the computing device 1000 and other devices may be used.

The computing device 1000 may include one or more input devices 1034 such that a user may enter commands and information (e.g., a keyboard, trackpad, or mouse). These and other input devices may be coupled to the server by one or more interfaces 1038, such as a serial port interface, parallel port, or universal serial bus (USB). The computing device 1000 may further include a display 1022, such as a touchscreen display.

The computing device 1000 may include a variety of tangible processor-readable storage media and intangible processor-readable communication signals. Tangible processor-readable storage can be embodied by any available media that can be accessed by the computing device 1000 and can include both volatile and nonvolatile storage media and removable and non-removable storage media. Tangible processor-readable storage media excludes intangible, transitory communications signals (such as signals per se) and includes volatile and nonvolatile, removable, and non-removable storage media implemented in any method, process, or technology for storage of information such as processor-readable instructions, data structures, program modules, or other data. Tangible processor-readable storage media includes, but is not limited to, RAM, ROM, EEPROM, flash memory or other memory technology, CDROM, digital versatile disks (DVD) or other optical disk storage, magnetic cassettes, magnetic tape, magnetic disk storage, or other magnetic storage devices, or any other tangible medium which can be used to store the desired information and which can be accessed by the computing device 1000. In contrast to tangible processor-readable storage media, intangible processor-readable communication signals may embody processor-readable instructions, data structures, program modules, or other data resident in a modulated data signal, such as a carrier wave or other signal transport mechanism. The term “modulated data signal” means a signal that has one or more of its characteristics set or changed in such a manner as to encode information in the signal. By way of example, and not limitation, intangible communication signals include signals traveling through wired media such as a wired network or direct-wired connection, and wireless media such as acoustic, RF, infrared, and other wireless media.

Clause 1. A method of renaming named objects within an application, the method comprising: accessing names of the named objects stored in memory and context information corresponding to the named objects within the application, each named object corresponding to an object name, the context information including object attributes of the named objects and an object hierarchy specifying hierarchical relationships among the named objects within the application; constructing one or more suggested names for a named object of the named objects by generating a generative artificial intelligence model input including at least a portion of the context information and requesting generation of the one or more suggested names based on the at least the portion of the context information included in the generative artificial intelligence model input; receiving the one or more suggested names from execution of a generative artificial intelligence model on the generative artificial intelligence model input; presenting the one or more suggested names for the named object; receiving a selection of a suggested name to yield a selected suggested name corresponding to the named object; and renaming the named object in the memory by replacing the object name corresponding to the named object stored in the memory with the selected suggested name.

Clause 2. The method of clause 1, wherein the context information further includes an object layout specifying a position within the application of each named object of the named objects.

Clause 3. The method of clause 1, wherein the context information further includes an indication of a renamed object of the named objects, the renamed object being renamed to the object name from a previous name.

Clause 4. The method of clause 3, the application including a plurality of portions including a first portion and a second portion, the named object being located in the first portion, the renamed object being located in the second portion.

Clause 5. The method of clause 3, the application including a plurality of portions, the named object and the renamed object being located in a same portion of the plurality of portions.

Clause 6. The method of clause 1, the application including a plurality of portions, the named objects located in a portion of the plurality of portions, the object hierarchy specifying hierarchical relationships among the named objects within the portion.

Clause 7. The method of clause 1, the context information including a renaming scheme specifying a format for renaming suggestions.

Clause 8. A system for renaming named objects of an application, comprising: one or more hardware processors; an object names identifier stored in memory and executable by the one or more hardware processors and configured to perform operations comprising accessing names of the named objects stored in memory, each named object corresponding to an object name; a context information selector stored in the memory and executable by the one or more hardware processors and configured to perform operations comprising selecting context information corresponding to the named objects within the application, the context information including object attributes of the named objects and an object hierarchy specifying hierarchical relationships among the named objects within the application; an object names generator stored in the memory executable by the one or more hardware processors and configured to perform operations comprising one or more suggested names for a named object of the named objects by generating a generative artificial intelligence model input including at least a portion of the context information and requesting generation of the one or more suggested names based on the at least the portion of the context information included in the generative artificial intelligence model input; and an object renamer stored in the memory and executable by the one or more hardware processors and configured to perform operations comprising: receiving the one or more suggested names from execution of a generative artificial intelligence model on the generative artificial intelligence model input; presenting the one or more suggested names for the named object; receiving a selection of a suggested name to yield a selected suggested name corresponding to the named object; and renaming the named object in the memory by replacing the object name corresponding to the named object stored in the memory with the selected suggested name.

Clause 9. The system of clause 8, wherein the context information further includes an object layout specifying a position within the application of each named object of the named objects.

Clause 10. The system of clause 8, wherein the context information further includes an indication of a renamed object of the named objects, the renamed object being renamed to the object name from a previous name.

Clause 11. The system of clause 10, the application including a plurality of portions including a first portion and a second portion, the named object being located in the first portion, the renamed object being located in the second portion.

Clause 12. The system of clause 10, the application including a plurality of portions, the named object and the renamed object being located in a same portion of the plurality of portions.

Clause 13. The system of clause 8, the application including a plurality of portions, the named objects located in a portion of the plurality of portions, the object hierarchy specifying hierarchical relationships among the named objects within the portion.

Clause 14. The system of clause 8, the context information including a renaming scheme specifying a format for renaming suggestions.

Clause 15. One or more tangible processor-readable storage media embodied with instructions for executing on one or more processors and circuits of a computing device a process for renaming named objects of an application, the process comprising: accessing names of the named objects stored in memory and context information corresponding to the named objects within the application, each named object corresponding to an object name, the context information including object attributes corresponding to the named objects and an object hierarchy specifying hierarchical relationships among the named objects within the application; constructing one or more suggested names for a named object of the named objects by generating a generative artificial intelligence model input including at least a portion of the context information and requesting generation of the one or more suggested names based on the at least the portion of the context information included in the generative artificial intelligence model input; receiving the one or more suggested names from execution of a generative artificial intelligence model on the generative artificial intelligence model input; presenting the one or more suggested names for the named object via a user interface of a computing device for selection; receiving a selection of a suggested name via the user interface to yield a selected suggested name corresponding to the named object; and responsive to receiving an input at the user interface, renaming the named object in the memory by replacing the object name corresponding to the named object stored in the memory with the selected suggested name.

Clause 16. The one or more tangible processor-readable storage media of clause 15, wherein the context information further includes an object layout specifying a position within the application of each named object of the named objects.

Clause 17. The one or more tangible processor-readable storage media of clause 15, wherein the context information further includes an indication of a renamed object of the named objects, the renamed object being renamed to the object name from a previous name.

Clause 18. The one or more tangible processor-readable storage media of clause 17, the application including a plurality of portions including a first portion and a second portion, the named object being located in the first portion, the renamed object being located in the second portion.

Clause 19. The one or more tangible processor-readable storage media of clause 17, the application including a plurality of portions, the named object and the renamed object being located in a same portion of the plurality of portions.

Clause 20. The one or more tangible processor-readable storage media of clause 15, the application including a plurality of portions, the named objects located in a portion of the plurality of portions, the object hierarchy specifying hierarchical relationships among the named objects within the portion.

Clause 21. A system for renaming named objects within an application, the system comprising: means for accessing names of the named objects stored in memory and context information corresponding to the named objects within the application, each named object corresponding to an object name, the context information including object attributes of the named objects and an object hierarchy specifying hierarchical relationships among the named objects within the application; means for constructing one or more suggested names for a named object of the named objects by generating a generative artificial intelligence model input including at least a portion of the context information and requesting generation of the one or more suggested names based on the at least the portion of the context information included in the generative artificial intelligence model input; means for receiving the one or more suggested names from execution of a generative artificial intelligence model on the generative artificial intelligence model input; means for presenting the one or more suggested names for the named object; means for receiving a selection of a suggested name to yield a selected suggested name corresponding to the named object; and means for renaming the named object in the memory by replacing the object name corresponding to the named object stored in the memory with the selected suggested name.

Clause 22. The system of clause 21, wherein the context information further includes an object layout specifying a position within the application of each named object of the named objects.

Clause 23. The system of clause 21, wherein the context information further includes an indication of a renamed object of the named objects, the renamed object being renamed to the object name from a previous name.

Clause 24. The system of clause 23, the application including a plurality of portions including a first portion and a second portion, the named object being located in the first portion, the renamed object being located in the second portion.

Clause 25. The system of clause 23, the application including a plurality of portions, the named object and the renamed object being located in a same portion of the plurality of portions.

Clause 26. The system of clause 21, the application including a plurality of portions, the named objects located in a portion of the plurality of portions, the object hierarchy specifying hierarchical relationships among the named objects within the portion.

Clause 27. The system of clause 21, the context information including a renaming scheme specifying a format for renaming suggestions.

Some implementations may comprise an article of manufacture, which excludes software per se. An article of manufacture may comprise a tangible storage medium to store logic and/or data. Examples of a storage medium may include one or more types of computer-readable storage media capable of storing electronic data, including volatile memory or nonvolatile memory, removable or non-removable memory, erasable or non-erasable memory, writeable or re-writeable memory, and so forth. Examples of the logic may include various software elements, such as software components, programs, applications, computer programs, application programs, system programs, machine programs, operating system software, middleware, firmware, software modules, routines, subroutines, operation segments, methods, procedures, software interfaces, application program interfaces (API), instruction sets, computing code, computer code, code segments, computer code segments, words, values, symbols, or any combination thereof. In one implementation, for example, an article of manufacture may store executable computer program instructions that, when executed by a computer, cause the computer to perform methods and/or operations in accordance with the described embodiments. The executable computer program instructions may include any suitable types of code, such as source code, compiled code, interpreted code, executable code, static code, dynamic code, and the like. The executable computer program instructions may be implemented according to a predefined computer language, manner, or syntax, for instructing a computer to perform a certain operation segment. The instructions may be implemented using any suitable high-level, low-level, object-oriented, visual, compiled, and/or interpreted programming language.

The implementations described herein are implemented as logical steps in one or more computer systems. The logical operations may be implemented (1) as a sequence of processor-implemented steps executing in one or more computer systems and (2) as interconnected machine or circuit modules within one or more computer systems. The implementation is a matter of choice, dependent on the performance requirements of the computer system being utilized. Accordingly, the logical operations making up the implementations described herein are referred to variously as operations, steps, objects, or modules. Furthermore, it should be understood that logical operations may be performed in any order, unless explicitly claimed otherwise or a specific order is inherently necessitated by the claim language.

What is claimed is:

1. A method of renaming named objects within an application, the method comprising:
accessing names of the named objects stored in memory and context information corresponding to the named objects within the application, each named object corresponding to an object name, the context information including object attributes of the named objects and an object hierarchy specifying hierarchical relationships among the named objects within the application;
constructing one or more suggested names for a named object of the named objects by generating a generative artificial intelligence model input including at least a portion of the context information and requesting generation of the one or more suggested names based on the at least the portion of the context information included in the generative artificial intelligence model input;
receiving the one or more suggested names from execution of a generative artificial intelligence model on the generative artificial intelligence model input;
presenting the one or more suggested names for the named object;
receiving a selection of a suggested name to yield a selected suggested name corresponding to the named object; and
renaming the named object in the memory by replacing the object name corresponding to the named object stored in the memory with the selected suggested name.

2. The method of claim 1, wherein the context information further includes an object layout specifying a position within the application of each named object of the named objects.

3. The method of claim 1, wherein the context information further includes an indication of a renamed object of the named objects, the renamed object being renamed to the object name from a previous name.

4. The method of claim 3, the application including a plurality of portions including a first portion and a second portion, the named object being located in the first portion, the renamed object being located in the second portion.

5. The method of claim 3, the application including a plurality of portions, the named object and the renamed object being located in a same portion of the plurality of portions.

6. The method of claim 1, the application including a plurality of portions, the named objects located in a portion of the plurality of portions, the object hierarchy specifying hierarchical relationships among the named objects within the portion.

7. The method of claim 1, the context information including a renaming scheme specifying a format for renaming suggestions.

8. A system for renaming named objects of an application, comprising:
one or more hardware processors;
an object names identifier stored in memory and executable by the one or more hardware processors and configured to perform operations comprising accessing names of the named objects stored in memory, each named object corresponding to an object name;
a context information selector stored in the memory and executable by the one or more hardware processors and configured to perform operations comprising selecting context information corresponding to the named objects within the application, the context information including object attributes of the named objects and an object hierarchy specifying hierarchical relationships among the named objects within the application;
an object names generator stored in the memory executable by the one or more hardware processors and configured to perform operations comprising one or more suggested names for a named object of the named objects by generating a generative artificial intelligence model input including at least a portion of the context information and requesting generation of the one or more suggested names based on the at least the portion of the context information included in the generative artificial intelligence model input; and
an object renamer stored in the memory and executable by the one or more hardware processors and configured to perform operations comprising:
receiving the one or more suggested names from execution of a generative artificial intelligence model on the generative artificial intelligence model input;
presenting the one or more suggested names for the named object;
receiving a selection of a suggested name to yield a selected suggested name corresponding to the named object; and
renaming the named object in the memory by replacing the object name corresponding to the named object stored in the memory with the selected suggested name.

9. The system of claim 8, wherein the context information further includes an object layout specifying a position within the application of each named object of the named objects.

10. The system of claim 8, wherein the context information further includes an indication of a renamed object of the named objects, the renamed object being renamed to the object name from a previous name.

11. The system of claim 10, the application including a plurality of portions including a first portion and a second portion, the named object being located in the first portion, the renamed object being located in the second portion.

12. The system of claim 10, the application including a plurality of portions, the named object and the renamed object being located in a same portion of the plurality of portions.

13. The system of claim 8, the application including a plurality of portions, the named objects located in a portion of the plurality of portions, the object hierarchy specifying hierarchical relationships among the named objects within the portion.

14. The system of claim 8, the context information including a renaming scheme specifying a format for renaming suggestions.

15. One or more tangible processor-readable storage media embodied with instructions for executing on one or more processors and circuits of a computing device a process for renaming named objects of an application, the process comprising:
accessing names of the named objects stored in memory and context information corresponding to the named objects within the application, each named object corresponding to an object name, the context information including object attributes corresponding to the named objects and an object hierarchy specifying hierarchical relationships among the named objects within the application;
constructing one or more suggested names for a named object of the named objects by generating a generative artificial intelligence model input including at least a portion of the context information and requesting generation of the one or more suggested names based on the at least the portion of the context information included in the generative artificial intelligence model input;
receiving the one or more suggested names from execution of a generative artificial intelligence model on the generative artificial intelligence model input;
presenting the one or more suggested names for the named object via a user interface of a computing device for selection;
receiving a selection of a suggested name via the user interface to yield a selected suggested name corresponding to the named object; and
responsive to receiving an input at the user interface, renaming the named object in the memory by replacing the object name corresponding to the named object stored in the memory with the selected suggested name.

16. The one or more tangible processor-readable storage media of claim 15, wherein the context information further includes an object layout specifying a position within the application of each named object of the named objects.

17. The one or more tangible processor-readable storage media of claim 15, wherein the context information further includes an indication of a renamed object of the named objects, the renamed object being renamed to the object name from a previous name.

18. The one or more tangible processor-readable storage media of claim 17, the application including a plurality of portions including a first portion and a second portion, the named object being located in the first portion, the renamed object being located in the second portion.

19. The one or more tangible processor-readable storage media of claim 17, the application including a plurality of portions, the named object and the renamed object being located in a same portion of the plurality of portions.

20. The one or more tangible processor-readable storage media of claim 15, the application including a plurality of portions, the named objects located in a portion of the plurality of portions, the object hierarchy specifying hierarchical relationships among the named objects within the portion.
